(19) United States
(12) Patent Application Publication
(10) Pub. No.: US 2009/0210423 A1
(43) Pub. Date: Aug. 20, 2009

(54) METHODS AND SYSTEMS FOR MAINTAINING PERSONAL DATA TRUSTS

(75) Inventor: Duane R. Valz, Emeryville, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/031,993

(22) Filed: Feb. 15, 2008

(51) Int. Cl. G06F 7/06; G06F 17/30

(52) U.S. Cl. 707/9; 707/E17.014

(57) ABSTRACT

Methods and systems are provided that may be used to maintain personal data trusts in a computing environment. An exemplary system may include a repository adapted to store personal data, an identification agent adapted to identify at least one computing resource that may have personal data, a collection agent adapted to selectively retrieve the personal data and provide it to the repository for storage therein, and a disposition agent adapted to selectively control access to the collected and stored personal data.

### BACKGROUND

1. Field

The subject matter disclosed herein relates to network related data communications and processing, and more particularly to data collection and storage.

2. Information

Since the early 1990's, the Internet has undergone rapid growth and transformation. A number of key factors have contributed to this growth. As the infrastructure for the Internet continues to improve, the number of ways to access the Internet as well as the speed of such access enables a richer, more diverse set of interactions and experiences for Internet users. In addition to millions of individual contributors, an ever greater number of governmental, non-profit and commercial entities make ever more extensive bodies of information and content accessible via the World Wide Web, e-mail and other Internet access modalities.

These individuals and entities also provide increasingly sophisticated products, services and facilities for personal transactions and community involvement. From video and photo sharing, banking, blogging, and immersive gaming, to medical information delivery and shopping, the experiences available over the Internet are targeted to all aspects of a user's everyday life.

As the general population becomes more comfortable with Internet use, more of us every day handle sensitive financial transactions over the Internet and entrust a wider variety of institutions with Internet accessible financial accounts, property and other assets. Any one person may have literally dozens or hundreds of unique sites and services which they access from time to time. Some of these sites and services may have been used just once or very infrequently by a given user, but yet may contain relevant, sensitive data regarding that individual.

For this and other reasons, it may be beneficial to keep careful track of data associated with certain websites, web services, or other like on-line activities.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating certain resources of a computing environment including an exemplary personal data trust, according to an embodiment.

FIG. 2 is a flow diagram illustrating an exemplary method that may, for example, be implemented, at least in part, through the computing environment of FIG. 1 to maintain a personal data trust, according to an embodiment.

FIG. 3 is a block diagram illustrating certain exemplary processes, functions and/or other like resources that may be implemented to maintain a personal data trust according to an embodiment.

FIG. 4 is a block diagram illustrating certain device resources in an exemplary embodiment of a computing environment system that may be operatively adapted to provide a computing environment maintaining a personal data trust, for example, as in FIG. 1.

### DETAILED DESCRIPTION

It may be beneficial to keep careful track of data, such as, for example, data associated with transactions between various computing resources. With this in mind, some exemplary methods and systems are illustrated herein that may be implemented to maintain a Personal Data Trust (PDT) that may include “personal data” associated with an “individual”.

As used herein, the terms “maintain” and “maintaining” when used with regard to a PDT may, for example, include providing, establishing, populating, updating, supporting, or otherwise affecting in some manner information stored within or otherwise operatively associated with a PDT.

As used herein, the term “individual” may include a person, a group of people, an entity, an organization, or other like identifiable party that may be associated with a PDT and the information stored within or otherwise operatively associated with the PDT.

As used herein, the terms “information” and “data” may be used interchangeably. These terms are meant to encompass any type of information that may be represented in some manner using digital data. By way of example but not limitation, certain types of information such as text, graphic, image, video, audio, computer instructions and/or the like, may be represented digitally using binary data.

As referred to herein, “computing resources” relates to equipment and/or processes capable of performing one or more functions of a computing platform. For example, computing resources may comprise physical computing resources (e.g., processors, memory, input/output devices, software and/or firmware) or virtual computing resources (e.g., processes that are de-coupled from any particular physical computing resource). In one implementation, a computing resource may be associated with identification information. Accordingly, such a computing resource may be accessed for performing a function of a computing platform (e.g., to enable a particular application) according to the identification information.

With this in mind, the term “personal data” as used herein may refer to any type of information that may be in some manner associated with or of interest to an individual. By way of example but not limitation, information may be considered as personal data if it includes text, graphic, image, video, audio, computer instructions, and/or the like, that may be of some personal interest to the individual or may be associated with the individual.

In certain instances, such personal data may include information that is “private” in that there is some attempt to prevent wide or otherwise uncontained dissemination of such information. By way of example but not limitation, personal data may include bank account information for the individual and as such may be private information as it may be known only to the individual and the bank.

In certain instances, personal data may include information that is “public” in that there may be wide or otherwise uncontained dissemination of such information. Here, for example, information associated with an individual that is available though a widely accessible website, web page, or other like file or document over the Internet may be personal data that includes public information.

In certain implementations, a PDT may, for example, be limited to storing personal data that is either private or public information. In other implementations, a PDT may, for example, include personal data of which some may considered to be private information and some may be considered to be public information. In certain exemplary implementations, a PDT may be logically or otherwise partitioned into separately maintained and/or separately controlled private and public information sections.

In certain exemplary implementations, a PDT may include personal data that may be collected from one or more computing resources that may communicate over one or more networks or other like communication links. A process for collecting such personal data may be adapted to be selective in some manner. For example, in certain implementations a data collection agent may be adapted to selectively and possibly automatically access certain computing resources and retrieve or otherwise receive personal data that may be associated with a specific “transaction”. Such a data collection agent may, for example, be implemented using one or more computing resources.

As used herein, the term “transaction” may include, for example, any data exchange associated with either an individual and/or personal data of such individual, or otherwise of interest to such individual. For example, a transaction may include or occur as a result of an individual using a computing device to access or otherwise exchange data with another computing device. By way of example but not limitation, such a transaction may be associated with accessing a website, downloading a web page, accessing an on-line account, sending or receiving electronic mail, on-line chatting, instant messaging, downloading a file, uploading a file, posting an image, posting a video, etc. For example, such a transaction may be identified as being of interest to an individual based, at least in part, on user input (e.g., user identified transaction, a search term, a selection, etc.).

In certain exemplary implementations, a PDT may be adapted to selectively and possibly automatically identify personal data and/or computing resources. Here, such identified personal data and/or computing resources may be, or may have been, useful in locating personal data of interest (which can then be collected, for example). For example, in certain implementations a data identification agent may be provided and adapted to identify such personal data and/or computing resources. Such data identification agent may, for example, be adapted to identify certain transactions by monitoring activity associated with certain computer applications or other like processes, and/or employing a search engine or other like computing processes. Such data identification agent may, for example, be adapted to identify certain transactions based on a user identified transaction that may be selectively maintained by user input. Such a data identification agent may, for example, be implemented using one or more computing resources.

In certain implementations, a PDT may include personal data that is collected or otherwise provided without having to transmit information over a network or other like communication link. For example, an individual may provide or otherwise identify information directly to a PDT that may be implemented on a local personal computer or other like computing device. For example, such personal data may be introduced through an input device, a computer readable medium, a peripheral device (e.g., scanner, camera, microphone, etc.), a computer application or other like process, etc.

In certain implementations, a PDT may, for example, be maintained using a single computing device. In other implementations, a PDT may, for example, be maintained using a plurality of computing devices. Indeed, in certain exemplary implementations a PDT and/or portions thereof may be distributed across a plurality computing devices.

In certain implementations, a PDT may, for example, be maintained for an individual by a trusted service using one or more computing devices. For example, a trusted service may provide a web based or other like on-line service that an individual interacts with to administer, delegate administration or otherwise access the PDT.

In certain implementations, a PDT may, for example, be adapted to selectively authorize another individual to access certain portions of personal data stored within or otherwise operatively associated with the PDT. By way of example but not limitation, a PDT may include a data disposition agent that may be adapted to assist in maintaining and controlling access to personal data stored within or otherwise operatively associated with the PDT. For example, such data disposition agent may employ certain policies regarding the access to, segmentation of, and/or retention of various personal data stored within or otherwise operatively associated with the PDT. Such a data disposition agent may, for example, be implemented using one or more computing resources.

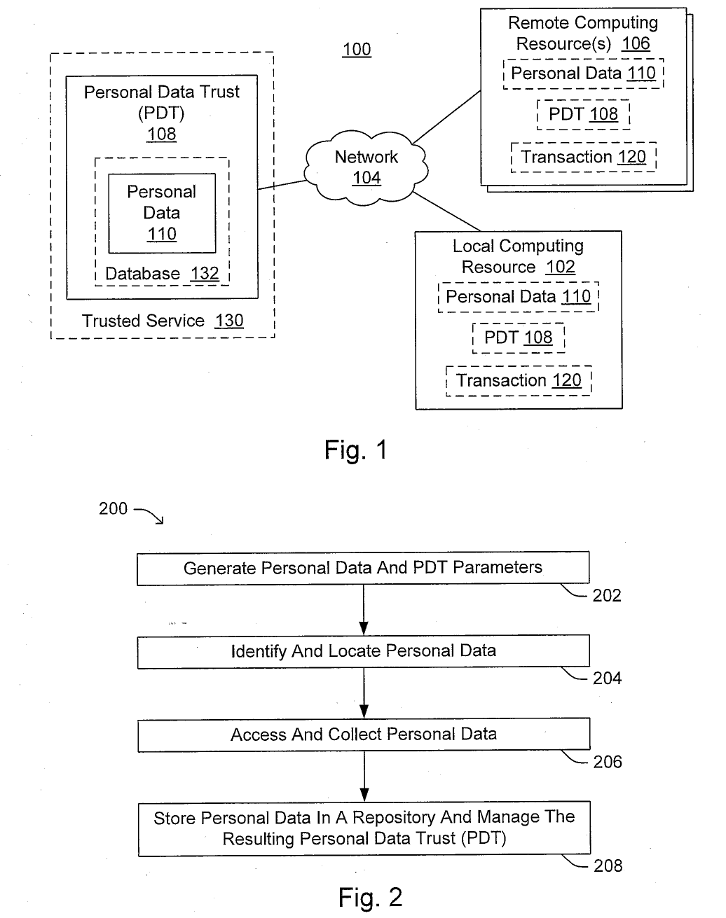

With the exemplary aspects presented above in mind, attention is now drawn to FIG. 1 wherein an exemplary computing environment 100 is illustrated. Computing environment 100 may include various computing resources that may be opertively coupled together through various network resources. Here, for example, a local computing resource 102 is coupled to a network 104 along with one or more remote computing resources 106.

A PDT 108 may also be coupled to network 104, as illustrated. Here, for example, PDT 108 is shown as including personal data 110. By way of example but not limitation, PDT 108 may include or otherwise employ a database 132 to store personal data 110. Also, as illustrated, all or portions of PDT 108 may be associated with a trusted service 130.

In certain implementations, all or portions of PDT 108 may be maintained in one or more computing resources other than or in addition to trusted service 130, for example, as illustrated by the dashed-lined boxes showing a PDT 108 in local computing resource 102 and remote computing resource 106.

As illustrated by the dashed-lined boxes showing personal data 110 in local computing resource 102 and remote computing resource 106, personal data may be distributed, replicated or otherwise maintained in one or more computing resources within environment 100. Similarly, as illustrated by the dashed-lined boxes showing a transaction 120 in local computing resource 102 and remote computing resource 106, transactions that may be associated with such personal data may occur or otherwise be identified using one or more computing resources within environment 100.

Reference is now made to FIG. 2, which is a flow diagram illustrating an exemplary method 200, of which all or portions of such method may be implemented in environment 100 to maintain at least one PDT 108.

At block 202 personal data may be generated or otherwise established. By way of example but not limitation, personal data 110 may be generated through, or as a result of, a transaction or other computing process and/or input to a computing device from another device or mechanism (e.g., a user input device, a computer readable medium, a peripheral device, another computing device, etc.). For example, at block 202, personal data may result from an individual accessing one or more websites, an article being published, a news report being broadcast, a video becoming available for download, a checking account balance being updated, a credit card charge being applied, a telephone number being listed, a chat room thread being updated, a membership being announced, a airline flight schedule being changed, etc.

Also, in certain implementations, at block 202 one or more PDT related parameters, such as, for example, data identification parameters, collection parameters, and/or management parameters may be generated or otherwise established for use in PDT 108. Some exemplary parameters and use thereof are described in greater detail in subsequent sections.

At block 204, at least one computing resource may be identified from which personal data may be accessible, for example, a computing resource may be identified based, at least in part, on a previous transaction associated with the computing resource. For example, a website or webpage may be identified, a network address may be identified, a database may be identified, etc. At block 204, personal data may be identified. For example, a document may be identified, a data file may be identified, an account may be identified, etc. Block 204 may, for example, include monitoring activity of one or more processes to identify transactions and/or personal data, searching computer resources for transactions and/or personal data, and/or accessing at least one user identified transaction, to identify personal data and/or the location of such personal data.

At block 206, an identified computing resource may be selectively accessed and at least a portion of the personal data therein or otherwise associated therewith may be collected (e.g., accessed, retrieved, copied, downloaded, received, etc.). For example, at block 206, the collected personal data may include one or more web pages or other like web documents, a published article, a broadcast news report, a downloaded video, an updated checking account balance, an electronic mail message, a chat room thread, membership information, airline flight schedules, etc.

At block 208, the collected personal data may be stored in a repository of the PDT. At block 208, the stored personal data may be selectively maintained and/or access thereto controlled, for example, based on established PDT access information and/or PDT polices that may be based, at least in part, on one or more of the management parameters that may be established at block 202.

Exemplary method 200 may, for example, be implemented using one or more computing resources and/or functions, such as those illustrated in FIGS. 1, and 3-4.

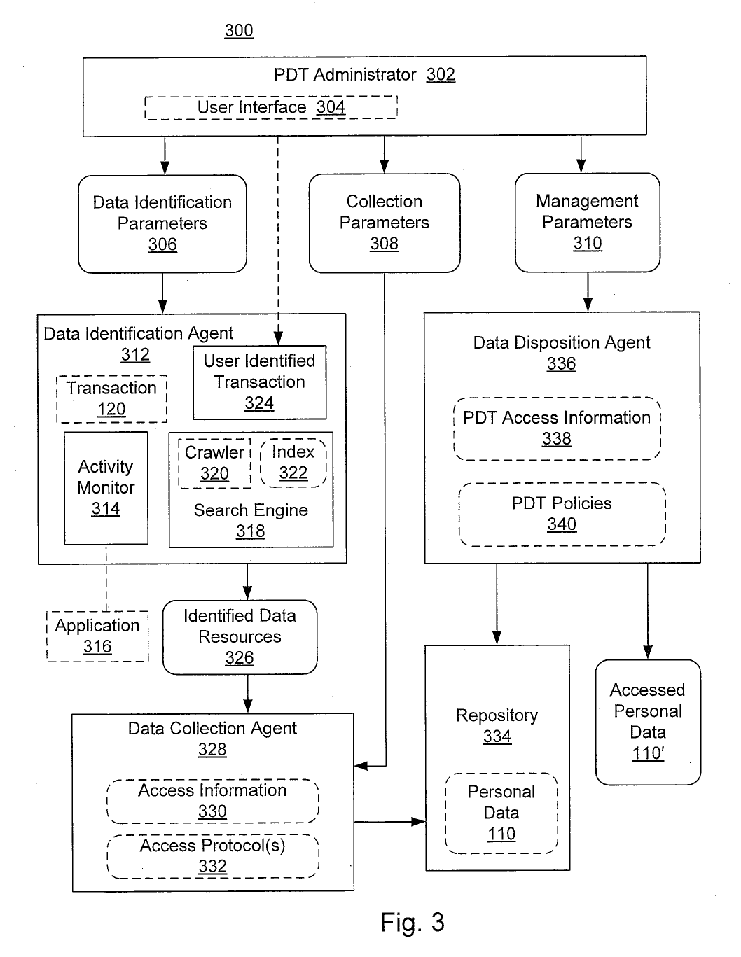

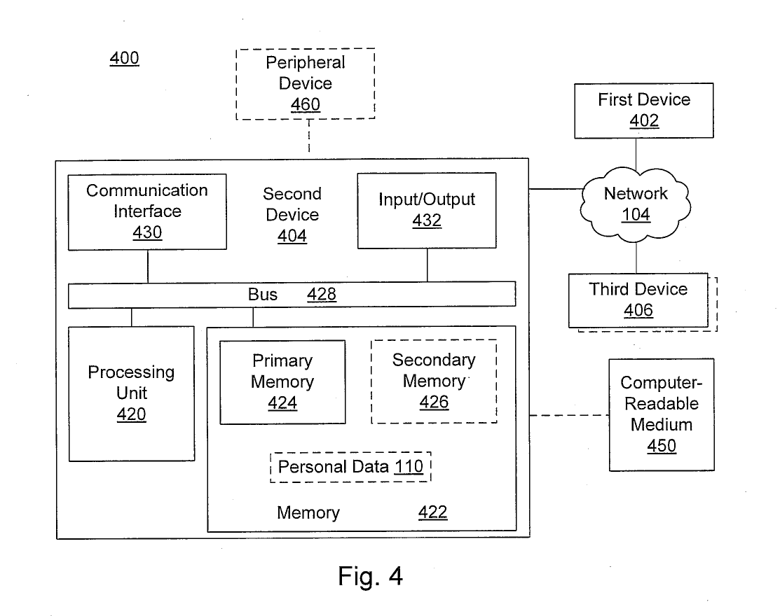

With this in mind, reference is now made to FIG. 3, which is a block diagram illustrating certain features and functions of an exemplary system 300. System 300 may, for example, be adapted to provide PDT 108 of FIG. 1. System 300 may, for example, be implemented using one or more computing resources such as those illustrated in FIGS. 1 and 4.

System 300 may include a PDT administrator 302 that may be adapted to allow an individual to set-up, control and access the PDT. PDT administrator 302 may be adapted to allow an individual to selectively control access privileges of others to personal data in the PDT.

In the example shown in FIG. 3, a PDT administrator 302 may be operatively coupled to a data identification agent 312, a data collection agent 328, and/or a data disposition agent 336. Some exemplary functions of each of these agents (e.g., computing processes) are described in greater detail below.

Here, in this example, PDT administrator 302 may also include or otherwise be operatively coupled to a user interface 304 adapted to allow a user to select or otherwise input information regarding the PDT, the individual, personal data, computing resources, or the like.

As shown in this example, PDT administrator 302 may maintain data identification parameters 306 that may be used by data identification agent 312, for example, to identify personal data and/or computing resources that may provide access to such personal data. Such data identification parameters 306 may, for example, be used by an activity monitor 314 that may be adapted to monitor one or more applications 316 and/or identify one or more transactions 120 associated with, and/or of interest to, the individual.

Additionally or alternatively, such data identification parameters 306 may be used by a search engine 318 to identify personal data and/or computing resources that may provide access to such personal data. Here, for example, search engine 318 may be adapted to use a crawler 320 or other like process to locate personal data and/or computing resources that may be associated with such personal data. Crawler 320 may maintain an index 322 that may include an identity or a location of personal data or computing resources that may be associated with such personal data. In certain exemplary implementations, data identification parameters 306 may include search terms or information regarding the individual and/or transactions that may be useful for such crawling, indexing and/or searching processes.

With regard to data identification agent 312, data identification parameters 306 may, for example, include a data type identifying parameter, a data time identifying parameter, a computing resource identifying parameter, a data size identifying parameter, a data file name identifying parameter, a data service identifying parameter, a data user identifying parameter, and/or other like parameters.

A data type identifying parameter may, for example, selectively identify a certain type of personal data that may be of interest for inclusion (or exclusion) from the PDT. For example, a user may specify through user interface 304 that personal data that includes image or video information associated in some manner with the individual may be desired for inclusion in (or exclusion from) the PDT.

A data time identifying parameter may, for example, selectively identify certain date(s) or time(s), or date or time period(s) associated with personal data that may be of interest for inclusion in (or exclusion from) the PDT. For example, a user may specify through user interface 304 that personal data may be desired for inclusion in (or exclusion from) the PDT based on the time that the personal data may have been generated, sent, received, edited, recorded, stored, displayed, printed, copied, or that is in some manner related to a defined time/date (e.g., time-stamped). For example, news/press reported information associated in some manner with the individual on a certain date, or prior to or following a certain date or time, may be desired for inclusion in (or exclusion from) the PDT.

A data size identifying parameter may, for example, selectively identify certain threshold or other like limiting factors for personal data that may be of interest for inclusion (or exclusion) from the PDT. For example, a user may specify through user interface 304 that personal data that has a file size less than or greater than a certain size (e.g., kilobytes, megabytes, etc.), may be desired for inclusion in (or exclusion from) the PDT.

A computing resource identifying parameter may, for example, identify in some manner a location of a computing resource that may provide access to and/or other information about personal data that may be of interest for inclusion (or exclusion) from the PDT. For example, a user may specify through user interface 304 that one or more computing resources associated with a bank account may have personal data that may be desired for inclusion in (or exclusion from) the PDT. Such computing resources may, for example, be identified by a network address, uniform resource locator (URL), or the like.

Similarly, a data service identifying parameter may, for example, identify in some manner a computing resource that may be associated with a service that may have personal data that may be of interest for inclusion (or exclusion) from the PDT. For example, a user may specify through user interface 304 a name of an on-line data service associated with a social networking site (e.g., My Space, Facebook, etc.) which may have personal data that may be desired for inclusion in (or exclusion from) the PDT.

A data user identifying parameter may, for example, identify in some manner the individual as might be related to personal data that may be of interest for inclusion (or exclusion) from the PDT. For example, a user may specify through user interface 304 a user name, a nickname, an alias, an account name, a professional affiliation, or other like identifying information which may be associated with personal data that may be desired for inclusion in (or exclusion from) the PDT.

A data file name identifying parameter may, for example, identify in some manner a name that is associated with a data file which may include personal data that may be of interest for inclusion (or exclusion) from the PDT. For example, a user may specify through user interface 304 a name of a published article, the author, publication, or other like name information.

PDT administrator 302 may, for example, be adapted to maintain at least one user identified transaction 324, which may identify personal data and/or computing resources that may include such personal data.

As shown in FIG. 3, data identification agent 312 may, for example, produce or maintain a list of identified computing resources 326. The identified computing resources 326 may, for example, include or otherwise specify computing resources and/or data files that may have personal data that may be collected and included in the PDT. Here, for example, data collection agent 328 may access identified computing resources 326 and based, at least in part, thereon attempt to collect such personal data and provide such personal data 110 to a repository 334. As illustrated, data collection agent 328 may, for example, be adapted to collect personal data 110 based, at least in part, on at least one of collection parameters 308.

In certain implementations, for example, collection agent 328 may be adapted to operatively access at least one computing resource based, at least in part, on access information 330. Access information 330 may, for example, be maintained through collection parameters 308. Access information 330 may, for example, be associated with an individual, a trusted service 130 (FIG. 1) and/or the like.

For example, data collection agent 328 may be adapted to act as a proxy for an individual, and/or to act on behalf of the individual with regard to a computing resource, using access information associated with the individual. Data collection agent 328 may be adapted to act as, and/or on behalf of, a trusted service 130 (FIG. 1) with regard to a computing resource, for example, using access information associated with the trusted service.

Access information 330 may, for example, be associated with an access protocol 332. Access protocol 332 may, for example, include an authentication or other like protocol. For example, access information 330 may include a user identification and password, and/or other login, security, authentication or, information that may be required to access a remote server or network property associated with a retirement or other like financial service account. Here, for example, access protocol 332 may be used to support the access process by negotiating or otherwise assisting or supporting the personal data collection attempt.

In certain implementations, collection parameters 308 may, for example, include a collection purpose identifying parameter, a collection time parameter, a collection type parameter, a collection update initiation parameter, and/or other like parameter.

A collection purpose identifying parameter may, for example, identify a purpose that may be associated with collecting certain personal data. For example, a collection purpose identifying parameter may identify that certain personal data be collected for a specific purpose such as, as part of an investigation, as part of an event, etc. Data collection agent 328 may be adapted, therefore, to selectively collect such personal data based, at least in part, on the collection purpose which may define whether the personal data is to be collected and if collected how the collected may be provided to and stored in repository 334. For example, personal data collected for a specified purpose may be physically and/or logically stored and/or handled in a specific manner in the PDT. As such, personal data that may be related to a confidential or otherwise sensitive purpose may be handled and/or stored in a more secure manner (e.g., protected, encrypted, backed-up, etc.).

Similarly, a collection type parameter may, for example, identify by type how certain personal data may be collected, stored, and/or otherwise handled in the PDT. For example, personal data that may include image, video or audio information files may be collected, stored, or handled in a manner that is different from how a text file may be collected, stored, or handled.

A collection time parameter may, for example, identify a time, date, or the like during which certain personal data may be collected. For example, a collection time parameter may identify that certain personal data may be collected once a week, daily, at 2 AM, after a business or market opens or closes, etc. Similarly, a collection update initiation parameter may, for example, identify a time, date, periodicity, or the like during which certain personal data may be collected. For example, a collection update initiation parameter may identify that certain personal data may be updated periodically, upon startup, etc.

As described thus far, in certain exemplary implementations, system 300 may include repository 334 adapted to store personal data 110, identification agent 312 adapted to identify at least one computing resource based, at least in part, on transaction 120 associated with a computing resource, and data collection agent 328 adapted to selectively access personal data associated with the computing resource, and provide the collected personal data 110 to repository 334.

In certain implementations, for example, transaction 120 may include at least one access transaction such as a browser process (e.g., searching the Internet), a client process (e.g., providing data), a server process (e.g., receiving data), a file transfer process (e.g., downloading or uploading a data file), an electronic communication (e.g., sending or receiving electronic mail), or other like computing process associated with the generation, exchange, sharing, modification, or other like processing of personal data. In certain implementations, for example, such a transaction may include a crawler process related transaction or other like transaction that may be associated with search index process adapted for use by search engine 318 or other like process.

In certain implementations, for example, identification agent 312 may be adapted to initiate a search process, such as, for example, of a search index 322 using search engine 318.

In certain implementations, for example, identification agent 312 may be adapted to selectively monitor at least one application 316 such as, for example, a browser application, a client application, a server application, a file transfer application, an electronic communication application, a peripheral device application, a user interface application, or the like. For example, identification agent 312 may include an activity monitor 314 or the like to monitor transactions, inputs, or the like, associated with application 316.

In certain implementations, for example, personal data 110 may include text data, graphics data, image data, video data, audio data, computer instruction data, and/or any other type of personal data.

System 300 may also include a data disposition agent 336, which may be operatively coupled to repository 334 and adapted to selectively manage and control access to personal data 110 stored therein. Data disposition agent 336 may, for example, include or otherwise establish PDT access information 338 and/or PDT polices 340. PDT access information 338 and/or PDT polices 340 may, for example, be based, at least in part, on one or more of the management parameters 310. Such management parameters 310 may, for example, be provided or otherwise specified in some manner through user interface 304, and may define how personal data 110 within repository 334 may be maintained and/or accessed.

For example, a PDT policy 340 may specify a data retention policy to be applied by data disposition agent 336 associated with all or selected portions of personal data 110. Such a policy may, for example, be based, at least in part, on one or more management parameters 310. By way of example but not limitation, management parameters 310 may specify that certain personal data (e.g., based on name, type, size, age, etc.) be removed from repository 334 after a certain date, time, event, etc.

PDT policy 340 and/or PDT access information 338 may, for example, be adapted to specify access rights for one or more other individuals with regard to all or selected portions of personal data 110 within repository 334. For example, a spouse may be granted access to all of personal data 110 at anytime, a business partner may be granted access to selected portion of personal data 110 perhaps during a limited period of time, and an executor may be granted access to all or portions of personal data 110 upon the passing or incapacitation of an individual (person). These and other potential users, if seeking to access personal data 110 in the PDT, may, for example, be required by data disposition agent 336 or other like processes to enter or otherwise present appropriate security or other like authenticating information which may be verified based, at least in part, on PDT access information 338. As shown, upon successfully engaging data disposition agent 336, such a user and/or the individual may then access or otherwise receive accessed personal data 110′.

The exemplary methods and systems presented above may be of particular use if there may be, over time, many gigabytes or even terabytes of information about any given individual stored among many computing resources. Such methods and systems may allow sensitive personal data to identified, collected and maintained in a PDT.

The exemplary methods and systems presented above may be provided as part of a trusted service which may operate in accordance with certain data collection relationships and protocols with a wide variety of merchants, vendors, service providers, publishers, and other “transactional partners” that may associated with or of interest to an individual.

As illustrated in the exemplary methods and systems presented above, a PDT may, for example, include one or more database or other like repositories which may be segmented depending on factors such as security levels, privacy sensitivities, data types, data values, timestamps, activity, subject matter, access information, resource, access frequency, or other like factors.

As illustrated in the exemplary methods and systems presented above, a PDT may, for example, include one or more agents, modules, processes, application programs, or the like that may be adapted to identify personal data by monitoring activity, searching, and/or based on at least one user identified transaction.

As illustrated in the exemplary methods and systems presented above, a PDT may, for example, include one or more agents, modules, processes, application programs, or the like that may be adapted to negotiate permissions, adhere to certain access/data retrieval rights, and/or otherwise employ the requisite protocols to collect personal data from various computing resources.

As illustrated in the exemplary methods and systems presented above, a PDT may, for example, include one or more agents, modules, processes, application programs, or the like that may be adapted to organize collected personal data, administer policies, and control access to, or other dispensations of, personal data of the PDT.

In the exemplary methods and systems presented above, a PDT search functionality (e.g., search engine 318 of FIG. 3) may, for example, be adapted to operate in accordance with certain features of an Internet-based search engine, and/or may employ an Internet-based search engine. A PDT search functionality may, for example, be adapted to maintain one or more search terms and search indices associated in some manner with, or of interest to, an individual. As illustrated, such PDT search functionality may, for example, include or otherwise employ a crawler or other like process that may be adapted to scan computer resources to locate or otherwise identify personal data and to update a search index accordingly.

In the exemplary methods and systems presented above, a PDT collection functionality (e.g., data collection agent 328 of FIG. 3) may, for example, be adapted to access computing resources, both open and secured resources, to retrieve or otherwise collect personal data. Secured computing resources may be accessed by the PDT collection functionality using access information associated with the individual, such as, for example, a user ID and password, and/or other like authentication token, etc. In certain implementations, a secured computing resource may be accessed by the PDT collection functionality based, at least in part, on access information that grants permission as pre-identified by the individual. In certain examples, the PDT collection functionality may be adapted to act as a surrogate or proxy for the individual in some full or limited capacity.

In certain implementations, the PDT collection functionality may be adapted to act according to certain permissions/rights protocols through which computing resources may implement data access controls that allow protocol-authenticated agents (such as, for example, data identification agent 312, data collection agent 328, trusted service 130, etc.) to access and/or retrieve personal data. Such protocols may, for example, specify the types of personal data (financial information, image files, e-mails, etc.) and at what values-based sensitivity levels (privacy, financial, etc.) such agents could have access to, and/or the authentication procedures and verification levels that may be required to permit such access. Such a protocol may, for example, be adapted to identify whether additional authentication may be needed beyond what the agent may be able to provide at the time, and the agent may be adapted to seek such additional authentication from existing access information and/or through prompting the individual and/or trusted service for appropriate information/input.

Attention is now drawn to FIG. 4, which is a block diagram illustrating an exemplary embodiment of a computing environment system 400 that may be operatively associated with computing environment 100 of FIG. 1, for example.

Computing environment system 400 may, for example, include a first device 402, a second device 404 and a third device 406, which may be operatively coupled together through a network 104.

First device 402, second device 404 and third device 406 may each be representative of any device, appliance or machine that may be configurable to exchange data over network 104. By way of example but not limitation, any of first device 402, second device 404, or third device 406 may include: one or more computing devices or platforms, such as, e.g., a desktop computer, a laptop computer, a workstation, a server device, storage units, a mobile handset or the like.

Network 104 may be representative of one or more communication links, processes, and/or resources configurable to support the exchange of data between at least two of first device 402, second device 404 and third device 406. By way of example but not limitation, network 104 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 406, there may be additional like devices operatively coupled to network 408.

It is recognized that all or part of the various devices and networks shown in system 400, and the processes and methods as further described herein, may be implemented using or otherwise include hardware, firmware, software, or any combination thereof.

Thus, By way of example but not limitation, second device 404 may include at least one processing unit 420 that is operatively coupled to a memory 422 through a bus 428. Bus 428 may be representative of one or more conductive paths adapted to carry control, data, power, and/or other signals.

Processing unit 420 may be representative of one or more circuits configurable to perform at least a portion of a data computing procedure or process. By way of example but not limitation, processing unit 420 may include one or more processors, controllers, microprocessors, microcontrollers, application specific integrated circuits, digital signal processors, programmable logic devices, field programmable gate arrays, and the like, or any combination thereof.

Memory 422 may be representative of any data storage mechanism. Memory 422 may include, for example, a primary memory 424 and/or a secondary memory 426. Primary memory 424 may include, for example, a random access memory, read only memory, etc. While illustrated in this example as being separate from processing unit 420, it should be understood that all or part of primary memory 424 may be provided within or otherwise co-located/coupled with processing unit 420.

Secondary memory 426 may include, for example, the same or similar type of memory as primary memory and/or one or more data storage devices or systems, such as, for example, a disk drive, an optical disc drive, a tape drive, a solid state memory drive, etc. In certain implementations, secondary memory 426 may be operatively receptive of, or otherwise configurable to couple to, a computer-readable medium 450. Computer-readable medium 450 may include, for example, any medium that can carry and/or make accessible data, code and/or instructions for one or more of the devices in system 400.

Additionally, memory 422 may include personal data 110 associated with a PDT 108 (FIG. 1). Such data may, for example, be stored in primary memory 424 and/or secondary memory 426.

Second device 404 may include, for example, a communication interface 430 that provides for or otherwise supports the operative coupling of second device 404 to at least network 104. By way of example but not limitation, communication interface 430 may include a network interface device or card, a modem, a router, a switch, a transceiver, and the like.

Second device 404 may include, for example, an input/output 432. Input/output 432 may be representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 432 may include an operatively adapted display, speaker, keyboard, mouse, trackball, touch screen, data port, etc.

A peripheral device 460 may be opertively coupled to second device 404. Peripheral device 460 may, for example, include a scanner, a printer, a camera, a microphone, a personal digital assistant, a phone, a music player, a video player, a DVD player, or the like.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A system adapted to provide a personal data trust associated with an individual, the system comprising:
a repository adapted to store personal data;
an identification agent adapted to identify at least one computing resource associated with personal data based, at least in part, on a previous transaction associated with said computing resource;
a collection agent adapted to access said at least one computing resource, collect said personal data, and provide said personal data to said repository for storage therein; and
a disposition agent operatively coupled to said repository and adapted to selectively control access to said personal data stored therein.

2. The system as recited in claim 1, wherein said previous transaction comprises at least one access transaction selected from a group of access transactions comprising a browser transaction, a client transaction, a server transaction, a file transfer transaction, and an electronic communication transaction.

3. The system as recited in claim 1, wherein said identification agent is adapted to selectively monitor at least one application selected from a group of applications comprising a browser application, a client application, a server application, a file transfer application, an electronic communication application, a peripheral device application, and a user interface application.

4. The system as recited in claim 1, wherein said previous transaction comprises a crawler transaction associated with a search index adapted for use by a search engine.

5. The system as recited in claim 4, wherein said identification agent is adapted to initiate a search of said search index by said search engine.

6. The system as recited in claim 1, wherein said identification agent is responsive to at least one data identification parameter selected from a group of data identification parameters comprising a data type identifying parameter, a data time identifying parameter, a computing resource identifying parameter, a data size identifying parameter, a data file name identifying parameter, a data service identifying parameter, and a data user identifying parameter.

7. The system as recited in claim 1, wherein said collection agent is adapted to operatively access said at least one computing resource based, at least in part, on access information associated with the individual.

8. The system as recited in claim 1, wherein said collection agent is adapted to operatively access said at least one computing resource based, at least in part, on access information associated with a trusted service.

9. The system as recited in claim 1, wherein said collection agent is responsive to at least one collection parameter selected from a group of collection parameters comprising a collection purpose identifying parameter, a collection time parameter, a collection type parameter, and a collection update initiation parameter.

10. The system as recited in claim 1, wherein said repository comprises a database adapted to be selectively accessed and managed by said disposition agent, and wherein said disposition agent is responsive to at least one management parameter.

11. The system as recited in claim 1, and further comprising:
an administrator agent responsive to at least one user input and adapted to establish at least one parameter selected from a group of parameters comprising a data identification parameter, a collection parameter, and a management parameter.

12. A method for providing a personal data trust associated with an individual, the method comprising:
identifying at least one computing resource from which personal data is accessible based, at least in part, on a previous transaction associated with said computing resource;
accessing said at least one computing resource and collecting said personal data therefrom;
storing said collected personal data in a repository; and
selectively controlling access to said collected personal data stored in said repository.

13. The method as recited in claim 12, wherein said previous transaction comprises at least one access transaction selected from a group of access transactions comprising a browser transaction, a client transaction, a server transaction, a file transfer transaction, and an electronic communication transaction.

14. The method as recited in claim 12, wherein identifying said at least one computing resource comprises selectively monitoring transaction activity associated with at least one application selected from a group of applications comprising a browser application, a client application, a server application, a file transfer application, and an electronic communication application.

15. The method as recited in claim 12 wherein said previous transaction comprises a crawler transaction associated with a search index adapted for use by a search engine.

16. The method as recited in claim 15, wherein identifying said at least one computing resource comprises initiating a search of said search index by said search engine.

17. The method as recited in claim 12, wherein identifying said at least one computing resource comprises identifying said at least one computing resource based, at least in part, on at least one data identification parameter selected from a group of data identification parameters comprising a data type identifying parameter, a data time identifying parameter, a computing resource identifying parameter, a data size identifying parameter, a data file name identifying parameter, a data service identifying parameter, and a data user identifying parameter.

18. The method as recited in claim 12, wherein selectively accessing said at least one computing resource comprises operatively accessing said at least one computing resource based, at least in part, on access information associated with the individual.

19. The method as recited in claim 12, wherein selectively accessing said at least one computing resource comprises operatively accessing said at least one computing resource based, at least in part, on access information associated with a trusted service.

20. The method as recited in claim 12, wherein selectively accessing said at least one computing resource comprises selectively accessing said at least one computing resource based, at least in part, on at least one collection parameter selected from a group of collection parameters comprising a collection purpose identifying parameter, a collection time parameter, a collection type parameter, and a collection update initiation parameter.

21. The method as recited in claim 12, wherein said repository comprises a database, and wherein selectively controlling access to said collected personal data stored in said repository comprises selectively controlling access to said collected personal data based, at least in part, on at least one management parameter.

22. The method as recited in claim 12, and further comprising:
establishing at least one parameter selected from a group of parameters comprising a data identification parameter, a collection parameter, and a management parameter.

23. A computer program product, comprising computer-readable medium comprising instructions for causing at least one processing unit to:
provide at least a portion of a personal data trust associated with an individual by:
identifying at least one computing resource from which personal data is accessible based, at least in part, on a previous transaction associated with said computing resource;
accessing said at least one computing resource and collecting said personal data therefrom;
storing said collected personal data in a repository; and
selectively controlling access to said collected personal data stored in said repository.

24. The computer program product as recited in claim 23, wherein identifying said at least one computing resource comprises selectively monitoring transaction activity associated with at least one application selected from a group of applications comprising a browser application, a client application, a server application, a file transfer application, and an electronic communication application.

25. The computer program product as recited in claim 23, wherein identifying said at least one computing resource comprises initiating a search of said search index by said search engine.

26. The computer program product as recited in claim 23, wherein selectively accessing said at least one computing resource comprises operatively accessing said at least one computing resource based, at least in part, on access information associated with the individual.

27. The computer program product as recited in claim 23, wherein selectively accessing said at least one computing resource comprises operatively accessing said at least one computing resource based, at least in part, on access information associated with a trusted service.

28. A system adapted to provide a personal data trust associated with an individual, the system comprising:
means for identifying at least one computing resource from which personal data is accessible based, at least in part, on a previous transaction associated with said computing resource;
means accessing said at least one computing resource and collecting said personal data therefrom;
means for storing said collected personal data in a repository; and
means for selectively controlling access to said collected personal data stored in said repository.
